(19) United States
(12) Patent Application Publication
(10) Pub. No.: US 2020/0074058 A1
(43) Pub. Date: Mar. 5, 2020

(54) METHOD AND APPARATUS FOR TRAINING USER TERMINAL

(71) Applicant: Samsung Electronics Co., Ltd., Suwon-si (KR)

(72) Inventors: Jinwoo SON, Seoul (KR); Changyong SON, Anyang-si (KR); Jaejoon HAN, Seoul (KR); Sangil JUNG, Suwon-si (KR); Seohyung LEE, Seoul (KR)

(73) Assignee: Samsung Electronics Co., Ltd., Suwon-si (KR)

(21) Appl. No.: 16/527,332

(22) Filed: Jul. 31, 2019

(30) Foreign Application Priority Data
Aug. 28, 2018 (KR) 10-2018-0101475

(51) Int. Cl. G06F 21/32; G06N 3/08; G06N 3/04

(52) U.S. Cl. CPC G06F 21/32; G06N 3/0454; G06N 3/08

(57) ABSTRACT

Disclosed is a method and apparatus for training a user terminal. A user terminal may authenticate a user input using an authentication model of the user terminal, generate a gradient to train the authentication model from the user input, in response to a success in the authentication, accumulate the generated gradient in positive gradients, and train the authentication model based on the positive gradients.

### CROSS-REFERENCE TO RELATED APPLICATIONS

This application claims the benefit under 35 USC § 119(a) of Korean Patent Application No. 10-2018-0101475 filed on Aug. 28, 2018 in the Korean Intellectual Property Office, the entire disclosure of which is incorporated herein by reference for all purposes.

### BACKGROUND

### 1. Field

The following description relates to training a user terminal.

### 2. Description of Related Art

When training a recognizer using a server, a trained model distinguishes a number of user inputs. A model that distinguishes IDs of faces of more than ten thousand people may have a relatively high false acceptance rate (FAR). To decrease the FAR, a threshold to be compared to a feature needs to be adjusted to prevent a false acceptance of another person. Further, to prevent a false acceptance of the same person, the threshold needs to be adjusted by increasing a verification rate (VR), and an enrollment image needs to have representativeness.

To increase the VR, a method of adaptively and additionally enrolling various representation and postures of the face of a user is used. However, an inherent FAR of a training model still exists. Thus, research on a personalized training scheme for a user terminal is being carried out to increase the VR and decrease the FAR, thus, increasing the performance of a recognizer used in the user terminal.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a method for training a user terminal, the method including authenticating a user input using an authentication model of the user terminal, generating a gradient to train the authentication model from the user input, in response to a success in the authentication, accumulating the generated gradient in positive gradients, and training the authentication model based on the positive gradients.

The generating may include generating gradients for layers of the authentication model, and the positive gradients comprise positive gradients corresponding to the layers.

The accumulating may include accumulating the generated gradients in gradient containers corresponding to the respective layers.

The training further may include generating gradients to train the authentication model from negative inputs, accumulating the gradients from negative inputs in the negative gradients, and training the authentication model based on the positive gradients and the negative gradients.

The accumulating of the negative gradients may include generating negative gradients for layers of the authentication model, and accumulating the generated negative gradients in gradient containers corresponding to the respective layers.

The authentication model may be trained to perform an authentication, wherein the training may include optimizing parameters for layers of the authentication model based on the positive gradients and the negative gradients.

The negative gradients may include generating negative inputs from noise using a generative adversarial network (GAN).

The method may include obtaining first user inputs corresponding to first features pre-enrolled by the authentication model, extracting second features from the first user inputs using the authentication model, in response to the training being completed, and updating the first features with the extracted second features.

The authentication may be performed using a remaining portion excluding a portion of layers of the authentication model, and the generated gradient and the positive gradients correspond to the remaining portion.

The remaining portion may include at least one layer having an update level of the training being lower than a threshold.

The method may include obtaining middle features corresponding to first features pre-enrolled by the authentication model, the middle features corresponding to the remaining portion, extracting second features from the middle features using the remaining portion of the authentication model, in response to the training being completed, and updating the first features with the second features.

The generating may include extracting a feature from the user input using the authentication model implemented as a neural network, generating a loss of the authentication model based on the extracted feature and a pre-enrolled feature, and generating a gradient based on the generated loss.

The user input may include any one or any combination of a facial image, a biosignal, a fingerprint, or a voice of the user.

In another general aspect, there is provided an authentication method of a user terminal, the authentication method including obtaining an input to be authenticated, extracting a feature from the input using an authentication model of the user terminal, performing an authentication with respect to the input based on the feature and a pre-enrolled feature, generating a gradient to train the authentication model from the input and accumulating the generated gradient in positive gradients, in response to a success in the authentication, and performing an authentication with respect to a second user input.

In another general aspect, there is provided a user terminal, including a processor configured to authenticate a user input using an authentication model of the user terminal, generate a gradient to train the authentication model from the user input, in response to a success in the authentication, accumulate the generated gradient in positive gradients, and train the authentication model based on the positive gradients.

The processor may be configured to generate gradients for layers of the authentication model, and the positive gradients comprise positive gradients corresponding to the layers.

The processor may be configured to generate gradients to train the authentication model from negative inputs, accumulate the generated gradients from negative inputs in the negative gradients, and train the authentication model based on the positive gradients and the negative gradients.

The processor may be configured to obtain first user inputs corresponding to first features pre-enrolled by the authentication model, extract second features from the first user inputs using the authentication model, in response to the training being completed, and update the first features with the extracted second features.

The processor may be configured to authenticate the user input using a remaining portion excluding a portion of layers of the authentication model, and the generated gradient and the positive gradients correspond to the remaining portion.

The processor may be configured to obtain middle features corresponding to first features pre-enrolled by the authentication model, the middle features corresponding to the remaining portion, extract second features from the middle features using the remaining portion of the authentication model, in response to the training being completed, and update the first features with the second features.

In another general aspect, there is provided an apparatus including a sensor configured to receive an input from a user, a memory configured to store an authentication model and instructions, and a processor configured to execute the instructions to authenticate the input using the authentication model, generate a gradient based on a difference between a feature extracted from the input and an enrolled feature, in response to a success in the authentication, accumulate the gradient in positive gradients, and train the authentication model based on the positive gradients.

The processor may be configured to determine the success of the authentication based on a comparison of the difference to a threshold.

The processor may be configured to generate negative gradients from noise data, and an amount of negative gradients may be in proportion to an amount of positive gradients, and train the authentication model based on the positive gradients and the negative gradients.

Other features and aspects will be apparent from the following detailed description, the drawings, and the claims.

### BRIEF DESCRIPTION OF THE DRAWINGS

FIG. 1 is a diagram illustrating an example of a method of training a user terminal.

FIG. 2 illustrates an example of accumulating a positive gradient.

FIG. 3 illustrates an example of accumulating a negative gradient and updating a model.

FIG. 4 illustrates an example of updating enrollment features.

FIG. 5 illustrates an example of a method of training a user terminal.

FIGS. 6A and 6B illustrate examples of authentication and training operations.

FIG. 7 illustrates an example of authentication and training operations.

FIG. 8 illustrates an example of a configuration of an apparatus.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween. Likewise, expressions, for example, “between” and “immediately between,” and “adjacent to” and “immediately adjacent to” may also be construed as described in the foregoing. As used herein, the term “and/or” includes any one and any combination of any two or more of the associated listed items.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

The use of the term ‘may’ herein with respect to an example or embodiment, e.g., as to what an example or embodiment may include or implement, means that at least one example or embodiment exists where such a feature is included or implemented while all examples and embodiments are not limited thereto.

Also, in the description of example embodiments, detailed description of structures or functions that are thereby known after an understanding of the disclosure of the present application will be omitted when it is deemed that such description will cause ambiguous interpretation of the example embodiments.

Hereinafter, examples will be described in detail with reference to the accompanying drawings. In the drawings, like reference numerals are used for like elements.

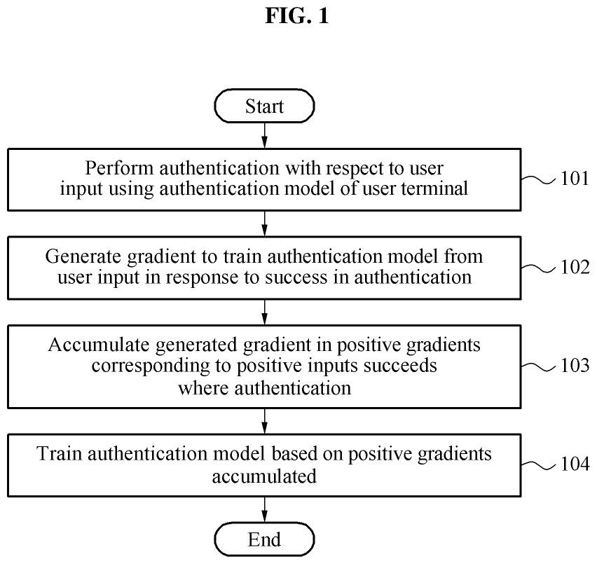

FIG. 1 is a diagram illustrating an example of a method of training a user terminal. The operations in FIG. 1 may be performed in the sequence and manner as shown, although the order of some operations may be changed or some of the operations omitted without departing from the spirit and scope of the illustrative examples described. Many of the operations shown in FIG. 1 may be performed in parallel or concurrently. One or more blocks of FIG. 1, and combinations of the blocks, can be implemented by special purpose hardware-based computer, such as a processor, that perform the specified functions, or combinations of special purpose hardware and computer instructions.

Referring to FIG. 1, in operation 101, an apparatus for training a user terminal, hereinafter, the training apparatus, performs an authentication with respect to a user input using an authentication model of a user terminal. The training apparatus is an apparatus which performs training of the user terminal. The training apparatus may be implemented on a hardware module that is configured to authenticate a user input. The user input is an input associated with a user and contains information that is to be authenticated. The user input includes information to be utilized to perform the authentication, such as, for example, a facial image, a biosignal, a fingerprint, or a voice of the user.

In an example, the user input is a feature that is suitable to be processed by the authentication model. The authentication model of the user terminal is a model that is trained to perform authentication and extracts a feature from the user input. The success of authentication is determined by matching between the feature extracted by the authentication model and a pre-enrolled feature.

In an example, the authentication model is implemented as a neural network and includes an input layer, at least one hidden layer, and an output layer. Each layer of the neural network includes at least one node, and a relationship between a plurality of nodes is defined non-linearly. The input layer of the authentication model includes at least one node corresponding to the user input, and the output layer of the authentication model includes at least one node corresponding to the feature extracted from the user input. In an example, the neural network may be a recurrent neural network (RNN) or a convolutional neural network (CNN). In an example, the CNN may be a deep neural network (DNN). The DNN may include a fully-connected network (FCN), a deep convolutional network (DCN), a long-short term memory (LSTM) network, and a grated recurrent units (GRUs). The authentication model converts a dimension of the user input to generate the feature. For example, the authentication model is trained to generate the feature from the user input, and the training apparatus updates the authentication model based on a newly obtained user input. In an example, the input information may be, for example, an image or voice. In an example, neural network may include a sub-sampling layer, a pooling layer, a fully connected layer, etc., in addition to a convolution layer.

The neural network may map input data and output data that have a nonlinear relationship based on deep learning to perform tasks such as, for example, object classification, object recognition, audio or speech recognition, and image recognition. The deep learning may be a type of machine learning that is applied to perform image recognition or speech recognition from a big dataset. The deep learning may be performed in supervised and/or unsupervised manners, which may be applied to perform the mapping of input data and output data.

In an example, the neural network may have a plurality of layers including an input, feature maps, and an output. In the neural network, a convolution operation between the input image, and a filter referred to as a kernel, is performed, and as a result of the convolution operation, the feature maps are output. Here, the feature maps that are output are input feature maps, and a convolution operation between the output feature maps and the kernel is performed again, and as a result, new feature maps are output. Based on such repeatedly performed convolution operations, results of recognition of characteristics of the input image via the neural network may be output.

In another example, the neural network may include an input source sentence, (e.g., voice entry) instead of an input image. In such an example, a convolution operation is performed on the input source sentence with a kernel, and as a result, the feature maps are output. The convolution operation is performed again on the output feature maps as input feature maps, with a kernel, and new feature maps are output. When the convolution operation is repeatedly performed as such, a recognition result with respect to features of the input source sentence may be finally output through the neural network.

In operation 102, the training apparatus generates a gradient to train the authentication model from the user input when the user input results in successful authentication. In an example, the training apparatus extracts a feature from the user input using the neural network-based authentication model. The training apparatus generates a loss of the authentication model based on the extracted feature and at least one pre-enrolled feature. The pre-enrolled feature is a feature extracted and pre-enrolled by the authentication model of the user terminal and is used as a criterion for authenticating the user input. For example, the pre-enrolled feature is a feature corresponding to a pre-enrolled facial image or fingerprint of the user.

In an example, the training apparatus generates the loss of the authentication model based on a predefined loss function. The training apparatus generates the loss based on a difference between the extracted feature and the pre-enrolled feature. In an example, the training apparatus generates at least one gradient based on the generated loss. The gradient is employed to optimize parameters of the authentication model and to train the authentication model. The training apparatus trains the authentication model using gradient descent.

In operation 103, the training apparatus accumulates the generated gradient in positive gradients corresponding to positive inputs where authentication succeeded. User inputs are divided into positive inputs and negative inputs depending on whether an authentication succeeds. For example, a positive input is an input where authentication succeeded, and a negative input is an input where authentication failed. In response to a success in authentication, the training apparatus generates a gradient based on a positive input. The gradient generated based on the positive input may be referred to as a positive gradient. In an example, the training apparatus accumulates the gradient generated at a current stage in pre-generated positive gradients.

The training apparatus generates a negative gradient and accumulates the generated negative gradient, which will be described further below. For example, the training apparatus generates the negative gradient based on an input generated by a negative image generator. The negative image generator is a module configured to generate an image corresponding to a negative input. In an example, the training apparatus accumulates the gradient generated at a current stage in pre-generated negative gradients.

In operation 104, the training apparatus trains the authentication model based on the accumulated positive gradients. In an example, the training apparatus determines whether to perform training and trains the authentication model using gradients that have been accumulated thus far depending on a result of the determining. In an example, the training apparatus trains the authentication model based on at least one of the positive gradients and the negative gradients. In an example, since the positive gradients are obtained when the user repeatedly performs authentication using the user terminal, the user terminal can update the authentication model by adapting to the user's individual changes over time through the positive gradients. Thus, the training apparatus updates the authentication model to adapt to a personal change in the user over time through the positive gradients. The training apparatus described above may be applicable to an authentication apparatus for performing an authentication using the authentication model or implemented to be integrated with the authentication apparatus. Further, the training apparatus may also be implemented independently of the authentication apparatus. In this example, the training apparatus generates a gradient and trains the authentication model based on a result of authentication performed by the authentication apparatus.

The training apparatus uses user inputs iteratively acquired from the user terminal, and thus, improves the authentication performance of the authentication model by personalizing training on the user terminal to increase a VR and decrease an FAR. As the authentication model is trained by the training apparatus, the authentication model is updated to a model customized to the user of the user terminal. The training apparatus enables the authentication model to perform self-learning on the user terminal without needing assistance from a server and to perform personalized learning with respect to various networks, such as face authentication, voice authentication, iris authentication, or fingerprint authentication.

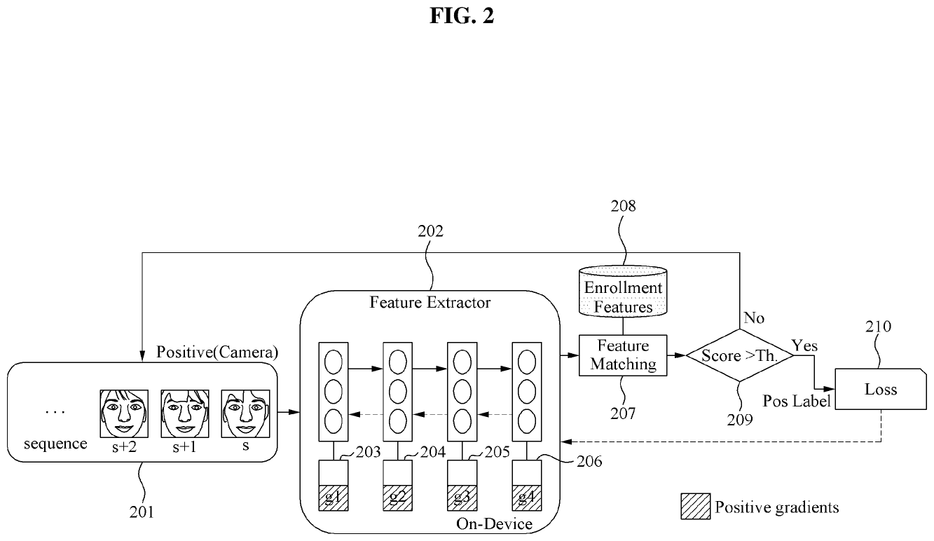

FIG. 2 illustrates an example of accumulating a positive gradient.

Referring to FIG. 2, a training apparatus obtains user inputs 201. As described above, if an authentication with respect to a user input succeeds, the user input is a positive input. Hereinafter, an example of accumulating a positive gradient corresponding to a positive input will be described. The training apparatus establishes a positive database using user inputs where authentication succeeded.

In an example, the training apparatus extracts a feature from a user input using an authentication model 202. In an example, the authentication model 202 is designed as a feature extractor including a plurality of layers and is implemented on a user terminal.

The training apparatus performs matching between a feature extracted using the authentication model 202 and pre-enrolled features 208, in operation 207. Here, the training apparatus is an authentication apparatus. In an example, the pre-enrolled features 208 are features that are previously extracted and enrolled by the authentication model 202. In an example, the training apparatus determines whether the authentication succeeds or fails based on a result of the matching. In an example, the training apparatus compares a score corresponding to the result of matching to a threshold score, in operation 209. When the score corresponding to the result of matching is less than the threshold score, the training apparatus determines that the authentication has failed with respect to the user input. When authentication fails, the training apparatus performs an authentication with respect to a subsequent user input, for example, a subsequent frame image including a face of the user.

When the score corresponding to the result of matching is greater than the threshold score, the training apparatus determines that the authentication for the user input has succeeded. When authentication succeeds, the training apparatus classifies the user input as a positive input. In an example, the training apparatus generates a loss 210 corresponding to the positive input. As described above, in an example, the training apparatus generates the loss 210 of the authentication model 202 based on a predefined loss function. For example, the loss function is defined as expressed by Equation 1.

loss_contrastive=Mean((1−label)*POW(euclidean_distance,n)+(label)*POW(CLAMP(margin-euclidean distance),n)) [Equation 1]

In Equation 1, loss_contrastive denotes the loss calculated by the loss function, and euclidean_distance denotes a difference between the feature extracted by the authentication model 202 and a pre-enrolled feature. POW(x, n) denotes a function which raises each element in x to the power of n. x denotes a vector to store a number of elements corresponding to a dimension of the feature output by the authentication model 202. CLAMP(x) denotes a function which changes a value of an element less than preset min, among elements in x, to min or changes a value of an element greater than preset max, among the elements in x, to max. Margin denotes a marginal value of a distance. For example, CLAMP(margin-euclidean distance) sets a value of an element with a margin-euclidean distance less than “0” to “0”. Mean(x) denotes a function which outputs an average of the elements in x.

Label denotes a label. In an example, the training apparatus calculates the loss using a positive label (label=0) in a case of a positive input and calculates the loss using a negative label (label=1) in a case of a negative input. For example, if the positive label (label=0) is used, the loss is calculated by the (1-label)*POW(euclidean_distance, n) term, and a positive gradient which decreases the difference between the feature extracted by the authentication model 202 and the pre-enrolled feature is generated. If the negative label (label=1) is used, the loss is calculated by the (label)*POW(CLAMP(margin-euclidean_distance), n) term, and a negative gradient which increases the difference between the feature extracted by the authentication model 202 and the pre-enrolled feature is generated.

The training apparatus generates positive gradients for layers of the authentication model 202. In an example, the positive gradients respectively correspond to the layers of the authentication model 202 and are gradients to optimize the respective layers.

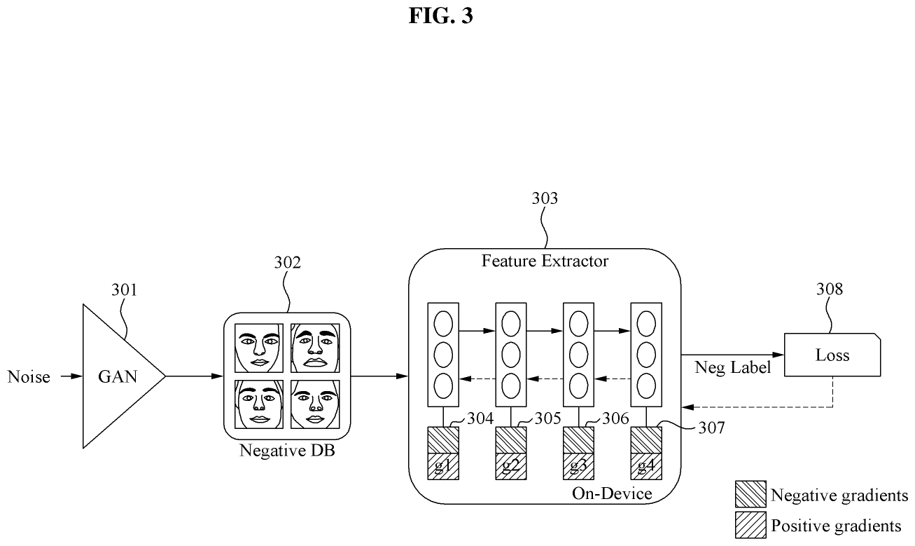

The training apparatus accumulates the generated positive gradients for the layers respectively in gradient containers 203, 204, 205, and 206 corresponding to the layers. In an example, pre-generated positive gradients are already accumulated respectively in the gradient containers 203, 204, 205, and 206. A gradient container is a space for storing a positive gradient or a negative gradient corresponding to a layer. The training apparatus uses the positive gradients accumulated respectively in the gradient containers 203, 204, 205, and 206 to train the authentication model 202. In an example, an operation of accumulating a positive gradient is performed at a recognition (inference) stage using the authentication model 202. An example of accumulating a negative gradient and training an authentication model will be described with reference to FIG. 3.

FIG. 3 illustrates an example of accumulating a negative gradient and updating a model.

Referring to FIG. 3, a training apparatus generates negative gradients to update training of an authentication model 303 and optimizes the authentication model 303 using the generated positive gradients and the negative gradients. The training apparatus obtains negative inputs 302. In an example, the training apparatus generates the negative inputs 302 from noise using a negative image generator. In an example, the negative image generator is a generative adversarial network (GAN) 301. For example, the training apparatus establishes a negative database using negative inputs 302 generated by the GAN 301 from a noise input.

The training apparatus establishes the negative database in consideration of the positive database corresponding to the positive inputs. In an example, the training apparatus determines a proportion of the negative inputs among all inputs based on a number of the positive inputs.

The training apparatus extracts a feature from a negative input using the authentication model 303 that is trained to perform an authentication. The training apparatus initiates training of the authentication model 303 based on a predefined time period, point in time, user setting, or training performance instruction and generates the negative inputs 302 in response to the training being initiated. In an example, an operation of updating the authentication model 303 is initiated according to a user setting. For example, when a user sleeps after connecting the user terminal to a charging cable, the operation of updating the authentication model 303 is initiated.

In an example, the training apparatus generates a loss 308 of the authentication model 303 based on the extracted feature and a pre-enrolled feature. The training apparatus calculates the loss 308 based on Equation 1, which is described above. For example, the training apparatus calculates the loss 308 using a difference between the feature extracted by the authentication model 303 and the pre-enrolled feature and negative labels. An operation of generating a negative gradient is similar to an operation of generating a positive gradient, and thus a detailed description will be omitted for brevity.

The training apparatus generates negative gradients for layers of the authentication model 303. The negative gradients respectively correspond to the layers of the authentication model 303 and are gradients to optimize the respective layers.

The training apparatus accumulates the generated negative gradients for the layers respectively in gradient containers 304, 305, 306, and 307 corresponding to the layers. In an example, pre-generated negative gradients and positive gradients are already accumulated respectively in the gradient containers 304, 305, 306, and 307. The training apparatus trains the authentication model 303 based on the negative gradients and positive gradients accumulated in the gradient containers 304, 305, 306, and 307. The training apparatus optimizes parameters for the layers of the authentication model 303 based on the negative gradients and positive gradients. Various training techniques including gradient descent are employed to optimize the parameters. The training apparatus updates the authentication model 303 using values accumulated in the gradient containers 304, 305, 306, and 307 and initializes the gradient containers 304, 305, 306, and 307 after the updating.

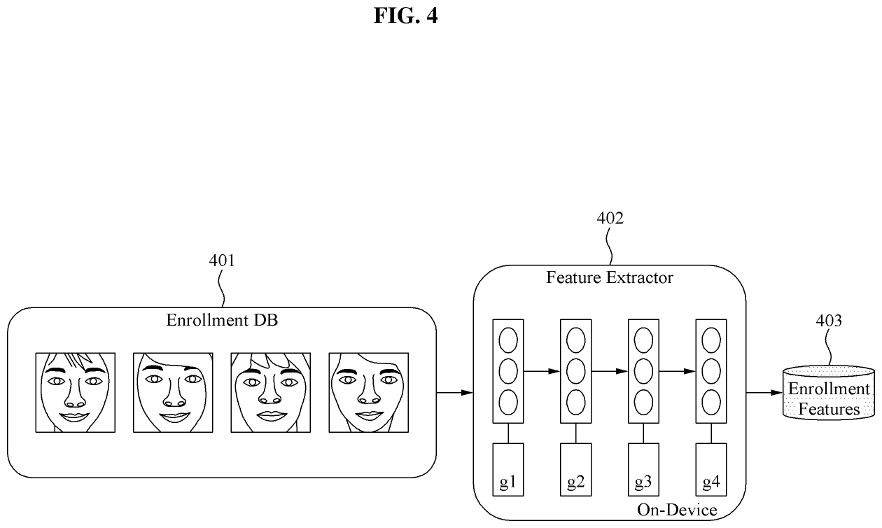

FIG. 4 illustrates an example of updating enrollment features.

Referring to FIG. 4, a training apparatus updates enrollment features using an updated authentication model 402. The training apparatus obtains first user inputs 401 corresponding to first features pre-enrolled by an authentication model that is yet to be updated. The first user inputs 401 are user inputs that are used to generate enrollment features using the authentication model that id yet to be updated and include, for example, pre-stored images initially enrolled by a user terminal for authentication.

The training apparatus updates a database of the enrollment features using the updated authentication model 402. For example, the training apparatus extracts second features 403 from the first user inputs 401 using the updated authentication model 402 when the training is complete. In an example, the training apparatus substitutes the second features 403 for the pre-enrolled first features. In a following authentication process, an authentication with respect to a user input is performed based on the updated enrollment features.

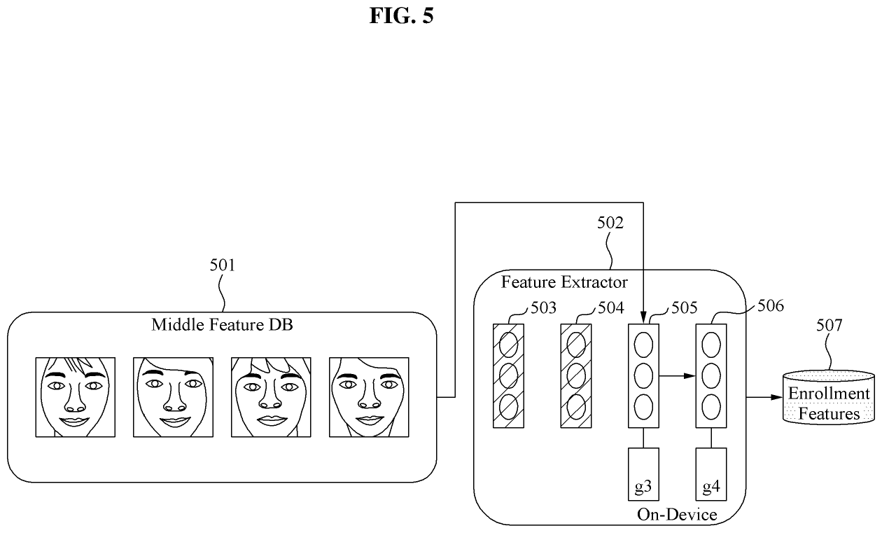

FIG. 5 illustrates an example of a method of training a user terminal.

Referring to FIG. 5, a training apparatus optimizes a remaining portion, for example, layers 505 and 506, excluding a portion, for example, layers 503 and 504, from the layers 503, 504, 505, and 506 of an authentication model 502 and trains the authentication model 502. In this example, an authentication with respect to a user input is performed using some of the layers of the authentication model 502, for example, by utilizing the remaining layers 505 and 506, of the authentication model 502. In an example, the remaining portion, for example, the layers 505 and 506, of the authentication model 502 are layers having updating levels that are lower than a threshold from among the layers 503, 504, 505, and 506 of the authentication model 502. In an example, to update enrollment features, a user terminal stores a feature corresponding to a middle layer, instead of storing an original image of a user, whereby personal information is protected.

When the authentication model 502 is updated in a manner that optimizes the remaining portion, for example, the layers 505 and 506, of the layers 503, 504, 505, and 506 of the authentication model 502, the training apparatus updates the enrollment features using the updated authentication model. The training apparatus obtains middle features 501 corresponding to first features pre-enrolled by the authentication model 502. The middle features 501 are input into the remaining portion, for example, the layers 505 and 506, of the layers 503, 504, 505, and 506.

In an example, the training apparatus updates a database of enrollment features using the trained authentication model 502. For example, the training apparatus extracts second features from the middle features 501 using the updated authentication model when training is completed. The training apparatus updates pre-enrolled first features 507 with the second features. In a following authentication process, an authentication with respect to a user input is performed based on the updated enrollment features.

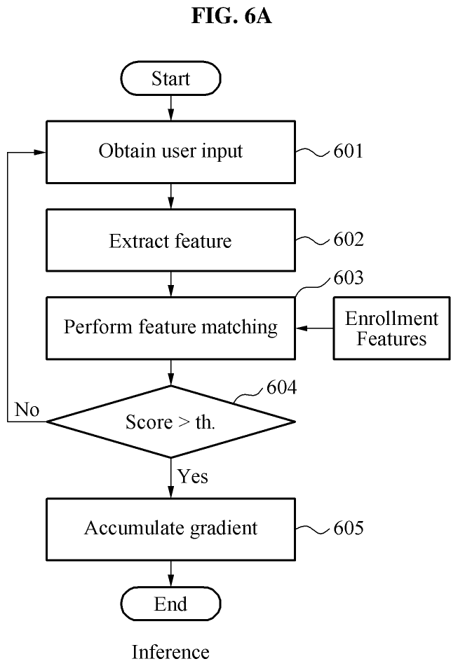

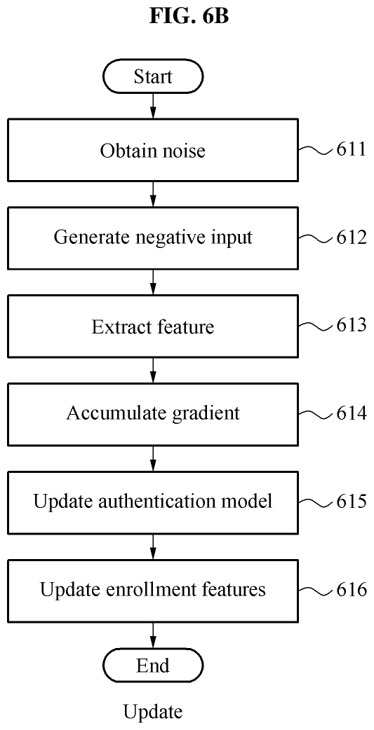

FIGS. 6A and 6B illustrate examples of authentication and training operations. The operations in FIGS. 6A and 6B may be performed in the sequence and manner as shown, although the order of some operations may be changed or some of the operations omitted without departing from the spirit and scope of the illustrative examples described. Many of the operations shown in FIGS. 6A and 6B may be performed in parallel or concurrently. One or more blocks of FIGS. 6A and 6B, and combinations of the blocks, can be implemented by special purpose hardware-based computer, such as a processor, that perform the specified functions, or combinations of special purpose hardware and computer instructions. In addition to the description of FIGS. 6A and 6B below, the descriptions of FIGS. 1-5 are also applicable to FIGS. 6A and 6B, and are incorporated herein by reference. Thus, the above description may not be repeated here.

As described above, a training apparatus or an authentication apparatus accumulates positive gradients while performing an authentication operation, and the training apparatus trains an authentication model based on positive gradients and negative gradients.

Referring to FIG. 6A, in operation 601, the training apparatus obtains a user input. In operation 602, the training apparatus extracts a feature from the user input. In operation 603, the training apparatus performs a matching between pre-enrolled features and the extracted feature. In operation 604, the training apparatus determines whether an authentication succeeds based on a result of the matching. In operation 605, the training apparatus generates and accumulates a positive gradient corresponding to the success in authentication.

Referring to FIG. 6B, in operation 611, the training apparatus obtains noise. In operation 612, the training apparatus generates a negative input by applying the noise to a negative image generator. In operation 613, the training apparatus extracts a feature from the negative input. In operation 614, the training apparatus generates and accumulates a negative gradient based on the extracted feature. In operation 615, the training apparatus trains an authentication model based on positive gradients and negative gradients. In operation 616, the training apparatus updates enrollment features using the trained authentication model.

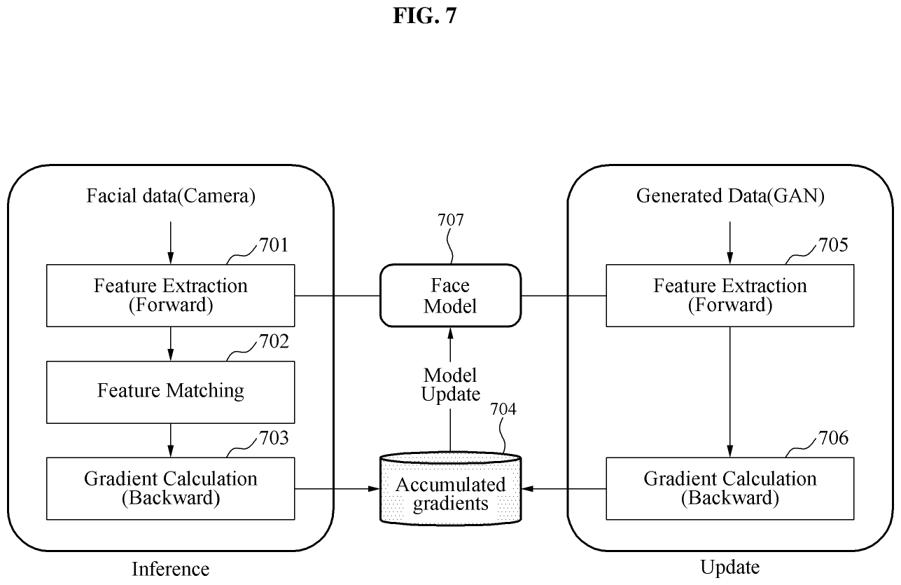

FIG. 7 illustrates an example of authentication and training operations.

Referring to FIG. 7, a user terminal includes an authentication module configured to perform an authentication, and a training module configured to perform training. In an example of face authentication, the authentication module of the user terminal includes a feature extraction module 701, a feature matching module 702, and a gradient calculation module 703. The feature extraction module 701 extracts a feature using an authentication model 707. The feature matching module 702 performs matching between the extracted feature and a pre-enrolled feature. The gradient calculation module 703 generates a positive gradient when authentication succeeds based on the matching performed by the feature matching module 702 and stores the positive gradient in a gradient database 704.

The training module of the user terminal includes a feature extraction module 705 and a gradient calculation module 706. The feature extraction module 705 extracts a feature from a negative input using the authentication model 707. The gradient calculation module 706 generates a negative gradient and stores the negative gradient in the gradient database 704. The training module trains the authentication model 707 using the gradients stored in the gradient database 704.

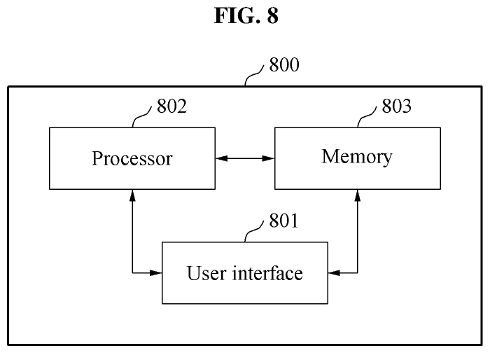

FIG. 8 illustrates an example of a configuration of an apparatus.

Referring to FIG. 8, an apparatus 800 includes a processor 802, a memory 803, and a user interface 801. The apparatus 800 is the authentication apparatus or training apparatus described above. The processor 802 includes at least one of the apparatuses described with reference to FIGS. 1 through 7 or performs at least one of the methods described with reference to FIGS. 1 through 7. The processor 802 refers to a data processing device configured as hardware with a circuitry in a physical structure to execute desired operations. For example, the desired operations may include codes or instructions included in a program. For example, the data processing device configured as hardware may include a microprocessor, a central processing unit (CPU), a processor core, a multicore processor, a multiprocessor, an application-specific integrated circuit (ASIC), and a field programmable gate array (FPGA). The processor 802 executes the program and controls the apparatus 800. Program codes to be executed by the processor 802 are stored in the memory 803. In an example, the processor 802 may be a graphics processor unit (GPU), reconfigurable processor, or any other type of multi- or single-processor configuration. The apparatus 800 is connected to an external device, for example, a personal computer or a network, through an input and output device (not shown) and exchanges data with the external device. Further details regarding the processor 802 is provided below.

The memory 803 stores information related to the authentication method or training method described above or stores a program to implement the authentication method or training method described above. The memory 803 stores a variety of information generated during the processing at the processor 802. In an example, the memory stores the enrollment features, extracted features, enrollment features, authentication model, accumulated gradients, and enrollment database. In addition, a variety of data and programs may be stored in the memory 803. The memory 803 may include, for example, a volatile memory or a non-volatile memory. The memory 803 may include a mass storage medium, such as a hard disk, to store a variety of data. Further details regarding the memory 803 is provided below.

The user interface 801 outputs the result of authentication that it receives from the processor 802, or displays a signal indicating the authentication. The user interface 801 is a physical structure that includes one or more hardware components that provide the ability to render a user interface, render a display, and/or receive user input. However, the user interface 801 is not limited to the example described above, and any other displays, such as, for example, computer monitor and eye glass display (EGD) that are operatively connected to the apparatus 800 may be used without departing from the spirit and scope of the illustrative examples described.

The authentication apparatuses, training apparatuses, apparatus 800, feature extractor and other apparatuses, units, modules, devices, and other components described herein with respect to FIGS. 1-8 are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In an example, the instructions or software includes at least one of an applet, a dynamic link library (DLL), middleware, firmware, a device driver, an application program storing the method of outputting the state information. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, card type memory such as multimedia card, secure digital (SD) card, or extreme digital (XD) card, magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method for training a user terminal, the method comprising:
authenticating a user input using an authentication model of the user terminal;
generating a gradient to train the authentication model from the user input, in response to a success in the authentication;
accumulating the generated gradient in positive gradients; and
training the authentication model based on the positive gradients.

2. The method of claim 1, wherein the generating comprises generating gradients for layers of the authentication model, and the positive gradients comprise positive gradients corresponding to the layers.

3. The method of claim 2, wherein the accumulating comprises accumulating the generated gradients in gradient containers corresponding to the respective layers.

4. The method of claim 1, wherein the training further comprises:
generating gradients to train the authentication model from negative inputs;
accumulating the gradients from negative inputs in the negative gradients; and
training the authentication model based on the positive gradients and the negative gradients.

5. The method of claim 4, wherein the accumulating of the negative gradients comprises:
generating negative gradients for layers of the authentication model; and
accumulating the generated negative gradients in gradient containers corresponding to the respective layers.

6. The method of claim 4, wherein the authentication model is trained to perform an authentication,
wherein the training comprises optimizing parameters for layers of the authentication model based on the positive gradients and the negative gradients.

7. The method of claim 4, wherein the accumulating of the negative gradients comprises generating negative inputs from noise using a generative adversarial network (GAN).

8. The method of claim 1, further comprising:
obtaining first user inputs corresponding to first features pre-enrolled by the authentication model;
extracting second features from the first user inputs using the authentication model, in response to the training being completed; and
updating the first features with the extracted second features.

9. The method of claim 1, wherein authentication is performed using a remaining portion excluding a portion of layers of the authentication model, and the generated gradient and the positive gradients correspond to the remaining portion.

10. The method of claim 9, wherein the remaining portion comprises at least one layer having an update level of the training being lower than a threshold.

11. The method of claim 9, further comprising:
obtaining middle features corresponding to first features pre-enrolled by the authentication model, the middle features corresponding to the remaining portion;
extracting second features from the middle features using the remaining portion of the authentication model, in response to the training being completed; and
updating the first features with the second features.

12. The method of claim 1, wherein the generating comprises:
extracting a feature from the user input using the authentication model implemented as a neural network;
generating a loss of the authentication model based on the extracted feature and a pre-enrolled feature; and
generating a gradient based on the generated loss.

13. The method of claim 1, wherein the user input comprises any one or any combination of a facial image, a biosignal, a fingerprint, or a voice of the user.

14. A non-transitory computer-readable storage medium storing instructions that, when executed by a processor, cause the processor to perform the method of claim 1.

15. An authentication method of a user terminal, the authentication method comprising:
obtaining an input to be authenticated;
extracting a feature from the input using an authentication model of the user terminal;
performing an authentication with respect to the input based on the feature and a pre-enrolled feature;
generating a gradient to train the authentication model from the input and accumulating the generated gradient in positive gradients, in response to a success in the authentication; and
performing an authentication with respect to a second user input.

16. A user terminal, comprising:
a processor configured to:
authenticate a user input using an authentication model of the user terminal,
generate a gradient to train the authentication model from the user input, in response to a success in the authentication,
accumulate the generated gradient in positive gradients, and
train the authentication model based on the positive gradients.

17. The user terminal of claim 16, wherein the processor is further configured to generate gradients for layers of the authentication model, and
the positive gradients comprise positive gradients corresponding to the layers.

18. The user terminal of claim 16, wherein the processor is further configured to:
generate gradients to train the authentication model from negative inputs;
accumulate the generated gradients from negative inputs in the negative gradients; and
train the authentication model based on the positive gradients and the negative gradients.

19. The user terminal of claim 16, wherein the processor is further configured to:
obtain first user inputs corresponding to first features pre-enrolled by the authentication model,
extract second features from the first user inputs using the authentication model, in response to the training being completed, and
update the first features with the extracted second features.

20. The user terminal of claim 16, wherein the processor is further configured to authenticate the user input using a remaining portion excluding a portion of layers of the authentication model, and
the generated gradient and the positive gradients correspond to the remaining portion.

21. The user terminal of claim 20, wherein the processor is further configured to:
obtain middle features corresponding to first features pre-enrolled by the authentication model, the middle features corresponding to the remaining portion,
extract second features from the middle features using the remaining portion of the authentication model, in response to the training being completed, and
update the first features with the second features.

22. An apparatus comprising:
a sensor configured to receive an input from a user;
a memory configured to store an authentication model and instructions; and
a processor configured to execute the instructions to:
authenticate the input using the authentication model,
generate a gradient based on a difference between a feature extracted from the input and an enrolled feature, in response to a success in the authentication,
accumulate the gradient in positive gradients, and
train the authentication model based on the positive gradients.

23. The apparatus of claim 22, wherein the processor is further configured to determine the success of the authentication based on a comparison of the difference to a threshold.

24. The method of claim 22, wherein processor is further configured to:
generate negative gradients from noise data, and an amount of negative gradients is in proportion to an amount of positive gradients, and
train the authentication model based on the positive gradients and the negative gradients.
